(19) United States
(12) Patent Application Publication
(10) Pub. No.: US 2014/0246973 A1
(43) Pub. Date: Sep. 4, 2014

(54) ADAPTABLE LIGHT UNIT

(71) Applicant: Timothy LEE, Commack, NY (US)

(72) Inventor: Timothy LEE, Commack, NY (US)

(21) Appl. No.: 14/197,192

(22) Filed: Mar. 4, 2014

Related U.S. Application Data
(60) Provisional application No. 61/771,650, filed on Mar. 1, 2013.

(51) Int. Cl. F21V 29/00; H05B 33/08

(52) U.S. Cl. CPC F21V 29/004; H05B 33/0806
USPC 315/53; 315/51; 362/382

(57) ABSTRACT

A system and device for an adaptable, energy-efficient light unit is herein provided, wherein the system and device allows for a longer life span of the light emitting device within the light unit, and for replacing a light emitting device within a light unit that does not require any tool or complex process. The system includes at least one light emitting unit, a light panel system frame, wherein the frame includes a power track, fixtures, and conductors, a lens, and may include a hanger. The device is a light emitting unit that includes at least a circuit board, wherein the circuit board may include ventilation holes and is made of heat conductive materials, at least one light emitting source, a voltage converter, power fixtures, wherein the power fixtures are configured to retrofit conventional light fixtures. The circuit board is configured to provide consistent voltage to the light emitting device.

### RELATED APPLICATIONS

This application claims the benefit of the earlier filing date under 35 U.S.C. §119(e) of U.S. Provisional Application Ser. No. 61/771,650 filed Mar. 1, 2013, entitled “Adaptable Light Unit,” the entirety of which is incorporated herein by reference.

### BACKGROUND AND TECHNICAL PROBLEMS

A light-emitting diode (LED) is commonly used as light source for light emitting devices and units. LEDs are used in a variety of configurations, including light panels for home and commercial use. Traditionally, the fixture of a LED-type panel is fixed and non-removable from the light emitting device. Consequently, once the service life of a light emitting device is over, a complex operation to remove the light emitting sources and fixtures that is part of the LED light panel, which includes the LED light fixture, must be performed to substitute or replace the LED light with the fixture using several types of tools. Therefore, the regular sockets are also not removable from the LED light panel, and its fixture.

Additionally, the life span of the LED light emitting device is shortened by a continuous operation and by frequent turning on/off the LED light emitting device. This is because a traditional LED-type panel operation results in heat buildup that will shorten the lifespan of the LED. Similar to common household appliances, the lifespan of an LED may also be severely shortened by voltage fluctuations because voltage spikes damage power caps in LED light emitting devices.

Accordingly, there is a demand for a LED light unit that is easy to fix or replace, and for a LED light unit that is capable of extending the life span of the LED light emitting device within the LED light unit and consequently the LED light unit itself.

### SOME EXAMPLE EMBODIMENTS

To respond to this demand, a system and apparatus for an adaptable light emitting unit, with a circuit board, wherein the circuit board may include ventilation holes and is made of heat conductive materials, with at least one light emitting source, with at least one power fixture, wherein the power fixtures are configured to retrofit conventional light fixtures; and a light panel system frame, wherein the panel system frame includes a power track, fixtures, and conductors, a lens, is herein provided. By providing a retrofit system, installation does not require a rewiring of existing fixtures. In at least one embodiment, the light panel system is a LED panel comprising one or more LED light units or banks. In accordance with embodiments, the apparatus comprises a unibody design.

The system and device herein provided allows for extending a life span of a light emitting unit and for replacing of a light emitting device within the light emitting unit in a simple manner and without requiring any type of tool. Extending the life span of a light emitting unit includes avoiding heating and heat buildup, and limiting voltage fluctuations. According to certain embodiments, an adaptable light emitting apparatus (or adaptable light unit) is disclosed and is energy efficient and configurable to retrofit conventional light fixtures, such as those associated with fluorescent lamps, compact fluorescent lamps (CFLs), HIGH-intensity discharge lamps, and incandescent light bulbs, light emitting diodes (LEDs) etc.

According to exemplary embodiments, an apparatus comprises a light emitting diode (LED) unit capable of being used with existing conventional light fixtures, such as light fixtures for Edison screw-type light bulbs, etc. is herein provided. In embodiments, the apparatus may comprise multiple LED panels, and/or configured with additional apparatuses. According to embodiments, the apparatus can be installed at existing conventional light fixtures without tools or a need to modify the existing light fixtures. The apparatus can be used for indoor and outdoor applications.

Various exemplary embodiments are described with respect to fixture of light emitting device, socket of light emitting device, and light emitting source (e.g., LED light) capable of being used on an existing fixture (e.g. fluorescent light fixture). It is contemplated that these embodiments have applicability to any light installation or fixture, apart from their use in the described adaptable light emitting device.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a front view of a LED panel.

FIG. 2 is a back view of a LED panel.

FIG. 3 is a side view of a LED panel.

FIG. 4 is a diagram of a design of a circuit.

FIG. 5 is a perspective view of an AC/DC integrated circuit.

FIG. 6 is a cross-section side view of a cooling off circuit board.

FIG. 7 is a cross-section side view of another cooling off circuit board.

FIG. 8 is a perspective view of cooling off circuit board.

FIG. 9 is a view of FIG. 8 with its the electronic components.

FIG. 10 is a perspective view of a cooling off circuit board with drilled ventilation holes.

### DESCRIPTION OF SOME EMBODIMENTS

In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices may be shown in block diagram form in order to avoid unnecessarily obscuring the embodiments.

In one embodiment, the adaptable light emitting apparatus, as herein disclosed, comprises a light emitting unit that includes at least a circuit plate with circuit components, including a circuit controller, at least one light emitting source, wherein the light emitting source may be a LED light, and power fixtures, wherein the power fixtures are configured to retrofit conventional light fixtures, or any variation of one or more of these devices or other devices. This means that the light emitting device may be detached from e.g. a socket and the socket may be detached from a fixture, for example in current 120 volt home electrical systems. According to exemplary embodiments, the light emitting source is one or more LED lights. In embodiments, the LED lights may be arranged in an LED panel.

In embodiments the adaptable light emitting device may is configurable to be used in various types of installations, such as an existing fluorescent light fixture may be comprised of one or more types of socket, such as an Edison screw type socket, a pin type socket, or a combination of any type of socket. This allows the adaptable light emitting device to be used in other types of fixtures, such as in an Edison screw type fixture, a panel type LED light fixture, or in more than one type of fixture. The adaptable light emitting device may be of several shapes, e.g. flat, bulb. In addition to the possibility of being of several shapes, the socket may be of several types of material and attachment mechanism e.g. magnet, as described in the figures.

The adaptable features, in exemplary embodiments, include the extendable mounting device as described in the figures, which permit the height and/or level of the device to be adjusted. Additionally, the light emitting device can be installed in various types of configurations as described in the figures. For example, in embodiments, the light emitting device may be installed and fixed by a clip, or any other fixation element, that may allow the panel to be hung in an overhead configuration.

It is also contemplated that the adaptable light emitting device may have at least the same efficiency of a LED light device, and in exemplary embodiments, a greater efficiency. This provides the user with at least the same incentives to use the adaptable light emitting device as the user would have using a LED light device (or any other type of device), such as energy efficiency, and long service life. In embodiments, a modular design of the device allows for future improvements in LED technology to be utilized.

The adaptable light emitting device may also emit at least the same light per watt as a LED lights, it may be at least as small as the LED lights, it may be at least as quickly to turn on and off as a LED light, it may emit lights of intended color without the use of any color filter, it may be ideal for uses subject to frequent on-off cycling, it may be dimmed at least as easily as LED light. Also, it may radiate at least as little heat as a LED light, it may be shock-resistant at least as much as a LED light, and may be at least as easy to focus the light being emitted as a LED light.

In embodiments, the device can be configured to create light emitting devices of various shapes, sizes, and forms. For example, the light emitting device can be formed having convex or concave shapes. According to embodiments, the modular design allows users to adjust the brightness of the device by adding or removing light panels and/or light sources.

Moreover, in embodiments, the device herein described may have advantages over a regular LED light device, such as non-over-heating properties (e.g., use of thermally conductive epoxy), which prevents device failure. Another advantage is that in various embodiments, the device may be applicable in various voltage settings and may be able to limit voltage fluctuation, as described further in this specification. In embodiments, the device may be used in an outdoor setting, and epoxy may be used to shield the apparatus from outdoor elements (e.g., water). In various embodiments, the use of epoxy eliminates the need for other types of heat sinks, including conventional fin type aluminum heat sinks

Additionally, in embodiments, the adaptable light emitting device is able to be attached and detached from an existing fixture without using a tool. The fixtures of the adaptable light emitting device, socket of the adaptable light emitting device, or the light emitting source of the adaptable light emitting device may use a heat dissipation material e.g. aluminum, epoxy, or a combination of one or more heat dissipation material, allowing the device to cool off. The use of epoxy may also allow the adaptable light emitting device to be used in extreme moisture conditions, may allow the lights to vary its color, the surface to smoothen and to eliminate light diffusing devices.

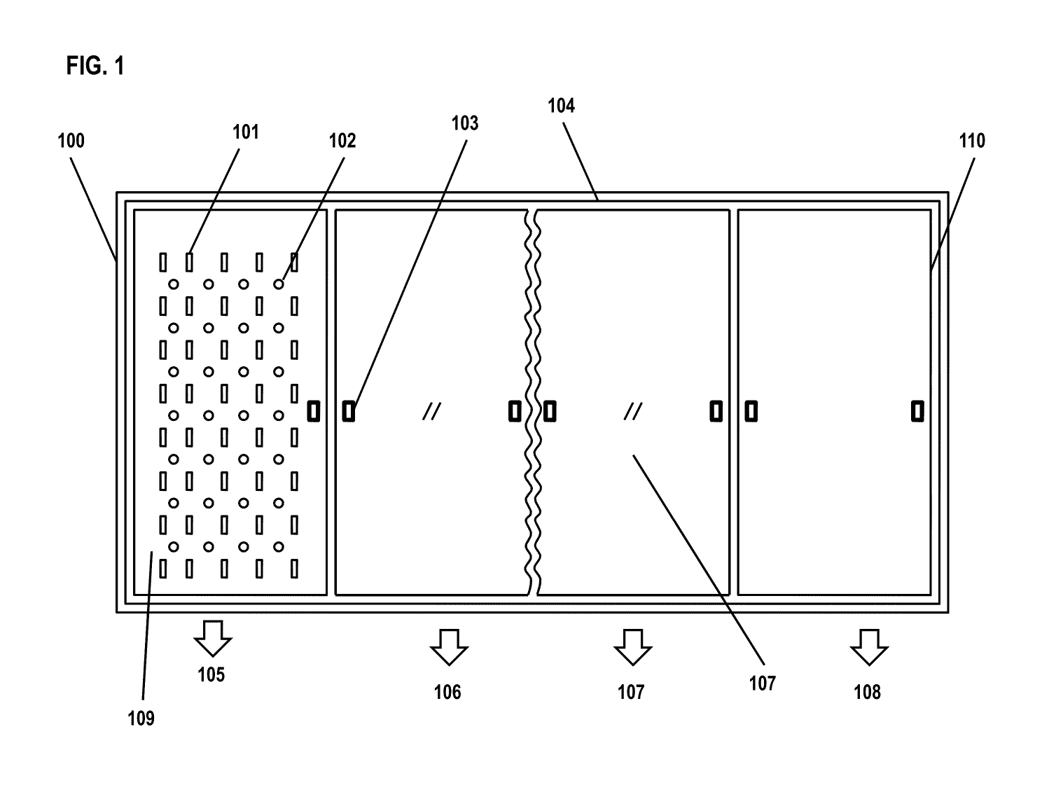

FIG. 1 is a front view of a LED panel 100, including one or more light emitting sources 101, one or more ventilation holes 102, at least one power fixture 103, a power track 104, lens 107, a circuit board 109, and a frame 110, according to embodiments. The first section 105 is shown without its lens. It is contemplated that one or more light emitting device 101 and the cooling off hole 102 may also present in the second section 106, third section 107, and fourth section 108, which is not shown in FIG. 1 because lenses 107 are installed in second section 106, third section 107, and fourth section 108. It is also contemplated that the ventilation holes 102 and the light emitting sources 101 may be disposed in circles or in any other desired form.

The circuit board 109 may be removed from the frame 110. By removing the circuit board 109, the light emitting sources 101, ventilation holes 102, lens 107, and power fixture 103 may also be removed from frame 110. Thereby, the light emitting device may be used separate from the panel.

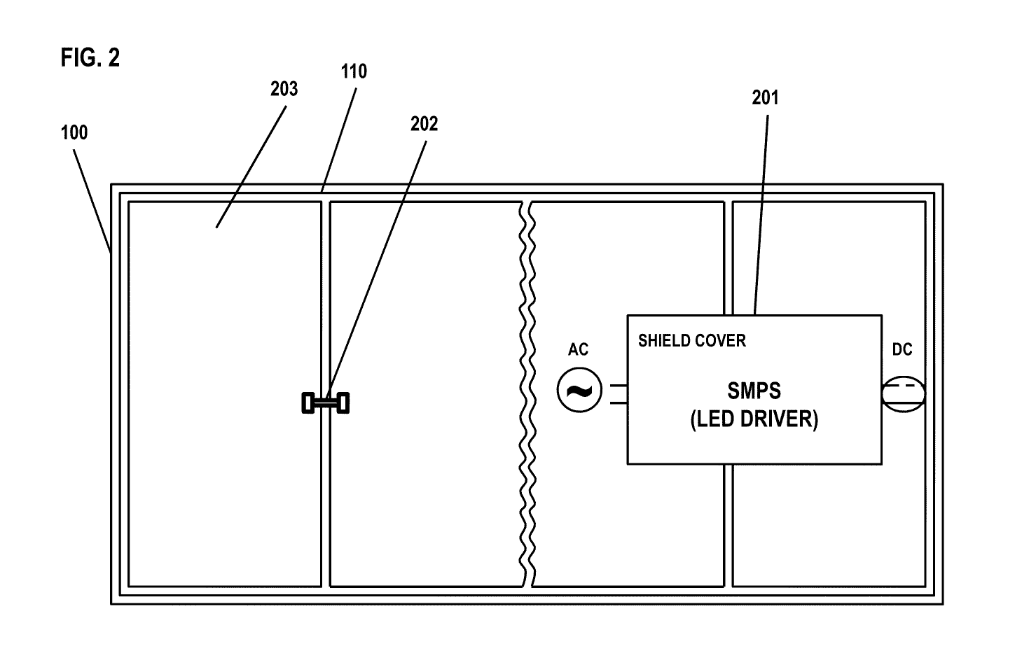

FIG. 2 is a back view of the LED panel 100, includes a power source 201 for driving the LED, a conductor 202, a plate 203, and a frame 110, according to embodiments. In embodiments, the output of the LED driver 201 may be configured to provide constant voltage or constant current, and can be adapted to an AC/DC power supply or a DC/DC power supply. In embodiments, the power source 201 can be a switched-mode power supply (SMPS) that includes a switching regulator for efficiently converting electrical power. The power source 201 is includes a shielded cover to avoid damaging or altering performance of the circuit, according to embodiments.

The adaptable light emitting device may include a power supply, which can be of any type such as an AC, a DC power supply, or a combination thereof. In embodiments, the power supply is an integrated power supply, having a single board construction. For example, the device is configured to having the LED and power supply. The power supply can operate with voltages from 9 volts to 600 volts, and/or with frequencies from 50 Hz to 40000 Hz. In embodiments, the power supply can be removed independently from the LED lights (e.g. in case of power failure), allowing power supply replacement without replacing the entire unit. In embodiments, a power track bar can serve as the power supply, and as a heat sink. Additionally, the power supply may have a voltage and frequency adjustor. The power supply component may be installed sideways, which allows reducing the height of the light device, and quicker heat dissipation. The single or multiple layers of aluminum, or other heat dissipation material, also works for the reduction of the height of the light bulb and for quicker heat dissipation.

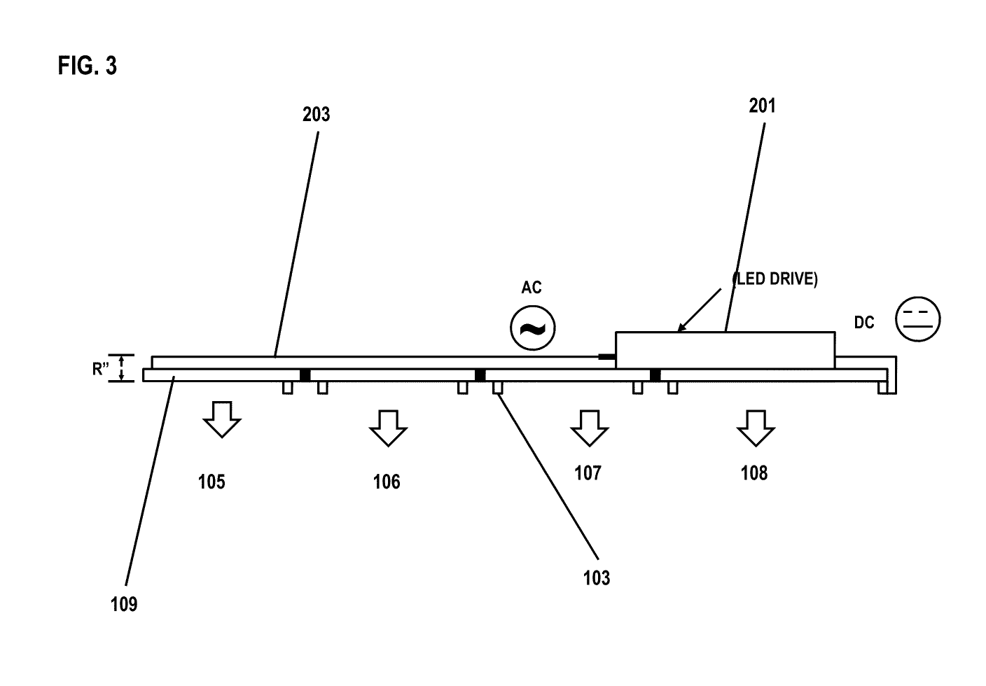

FIG. 3 is a side view of a LED panel 100, according to embodiments. In embodiments, the components of the LED panel 100 may be arranged to permit the removal of sections 105, 106, 107, and 108 can be removed as from the LED panel 100, as depicted in FIG. 3. In additional embodiments, the light emitting device may include built-in connectors, as opposed to bare wires, for ease of installation. In addition, the built-in connectors eliminate the need for additional housing to secure the light and provide a clean finish in hiding connections.

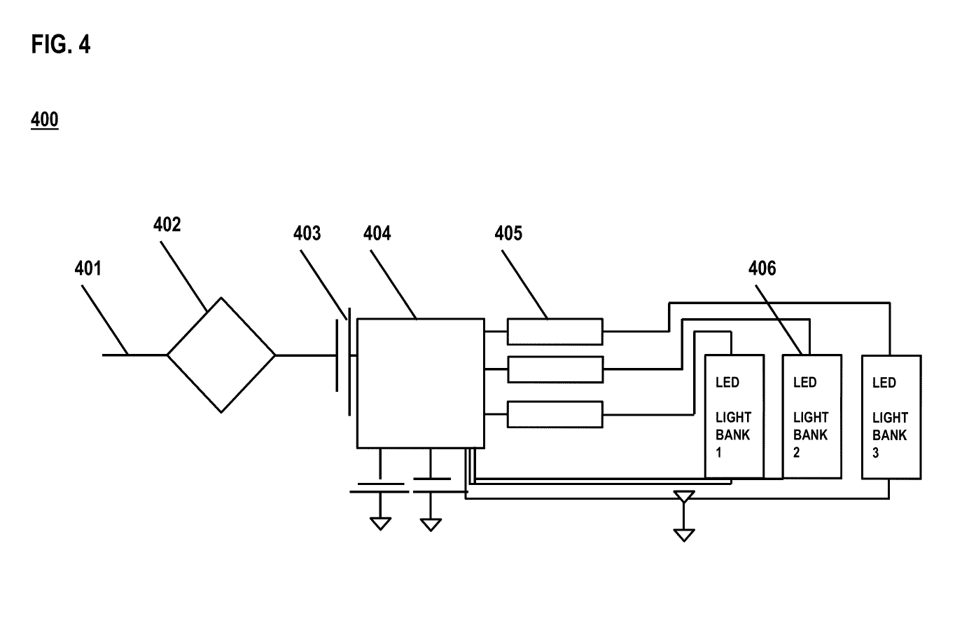

FIG. 4 is a diagram of a design of a circuit board, configured to provide steady flow electricity with regards to surges of electrical power, according to embodiments. FIG. 4 depicts an AC Input 401, a rectifier 402, an initial input controller 403, a multiple current regulator 404, a set of switchers 405, and a set of LED banks 406. The rectifier 402 may be a metal-oxide-semiconductor field-effect transistor or any other transistor that is capable of rectifying, modifying or switching the AC input. The initial input controller 403 may be a capacitor or any other device capable of smoothing out the voltage and/or limiting the amount of voltage fluctuation. In embodiments, the capacitor can be charged using a portion of voltage applied to the circuit that is not used to illuminate the LED light. The set of switchers 405 may be a low ohm resistor that is connected to the LED banks 406.

The circuit provided in FIG. 4 allows the light emitting unit to avoid production of excessive heat and heat buildup. As a result of less heat in the light emitting device, the life span of the light emitting unit will be longer.

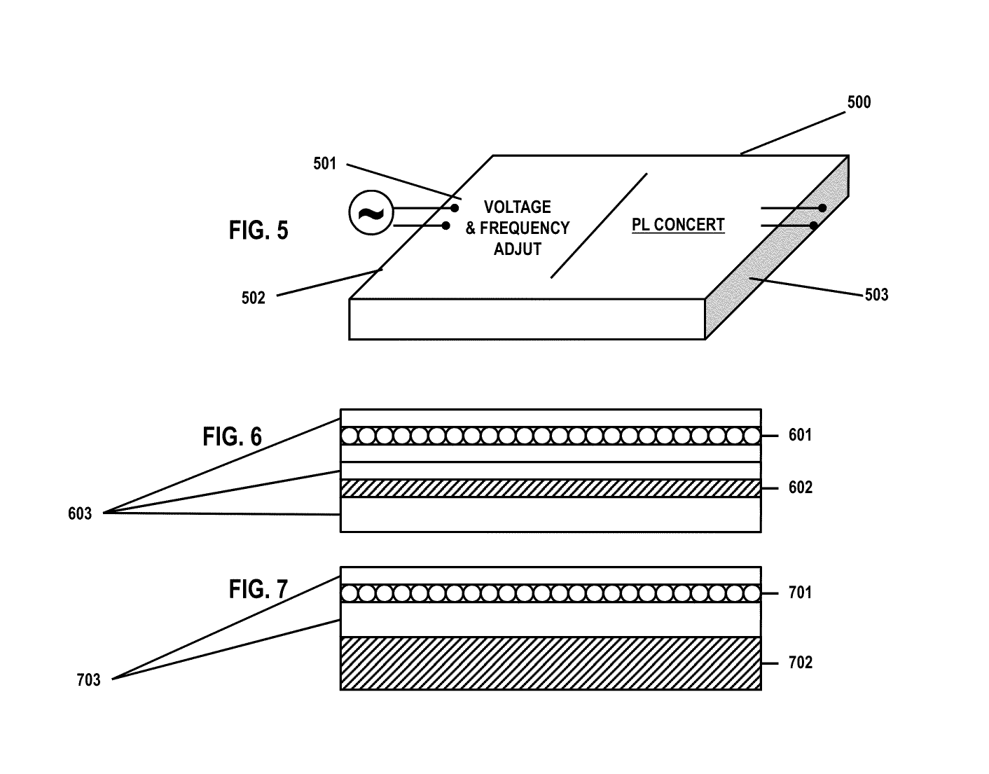

FIG. 5 is a perspective view of an AC/DC integrated circuit. The integrated circuit 500 may be included in the circuit board 109. The integrated circuit 500 receives electric power from the power supply 501. Once the electric power reaches the integrated circuit 500, the alternate current 502 is converted into direct current 503, the electric power will then reach the light emitting source 101. By converting alternate current 502 to direct current 502, the light emitting source 101 is more efficient, as opposed to applying alternate current to the light emitting source 101. The integrated circuit 109 is also the initial phase of the process of smoothing out the voltage and/or limiting the amount of voltage fluctuation described in FIG. 4. It is contemplated that power supply 501 may also be located in the integrated circuit 500. The plate of the board may be of semiconductor material such as silicon.

The adaptable light emitting device may be configured having a single or multiple layers of aluminum or several other materials, such as aluminum and epoxy, used as heat conductor material. The circuit board of the light emitting device, as described in the figures may be of 1 and a half inches thick, or any other thickness. One or more boards may have one or more drilled holes in its base, which may be of 2, or 3 millimeters, or other sizes, to provide ventilation and heat management.

As herein described, the apparatus, may reduce the costs for the user of the high priced regular LED light installations. Because the user is capable to interchangeably use mechanism for one type of light (e.g. fluorescent) with another mechanism of another type of light (e.g. regular LED light panel), the users may be able to sporadically use an initially expensive light emitting device that would may not typically be used if it was not for the adaptability of the devices and its installations. In another words, the user may have the advantages of using e.g. a LED light source and the advantage of other light emitting devices when it chooses to do so. Using the light emitting device, according to certain embodiments, reduces not only the costs of purchase itself, but also the costs of replacing them and the frequency in which replacement is required. Since it does not require complex operations for substitution, the user does not need to hire trained personnel to carry out the work. Additionally, the convenience of being able to replace a light emitting device of fluorescent light panel for an e.g. a LED light device or incandescent light emitting device, while keeping the fixture of the fluorescent light panel, may be priceless.

For users environmentally concerned, the device herein described is ideal. Because regular cool-white LEDs with high color temperature emit proportionally more blue light than conventional outdoor light sources, the cool-white LEDs can cause more light pollution than other light sources. A person using a LED light emitting device, in accordance with embodiments, may be able to change from a LED emitting source to a conventional outdoor light source (or to a light emitting device herein described) at the end of the day, when it is dark and the light pollution is significant. Consequently, the light pollution caused by a LED user may be reduced by simply substituting the LED emitting source to another light emitting source.

FIG. 6 is a cross-section side view of a cooling off circuit board. The circuit board 500 may have a circuit layer 601 that is isolated by isolation layers 603. In this embodiment, there are 4 isolation layers 603. Circuit board 500 also has an aluminum layer 602 that will dissipate heat and prevent heat buildup in the light emitting apparatus, and consequently, in the LED light panel 100.

FIG. 7 is a cross-section side view of another cooling off circuit board. The circuit board 500 may also have a circuit layer 701 that is isolated by isolation layer 703, wherein one of the isolation layers 703 is thicker when located between the circuit layer 701 and aluminum base 702. In this embodiment, the aluminum base 702 is much thicker than circuit layer 701, which provides for greater cooling off characteristic to the circuit board 500.

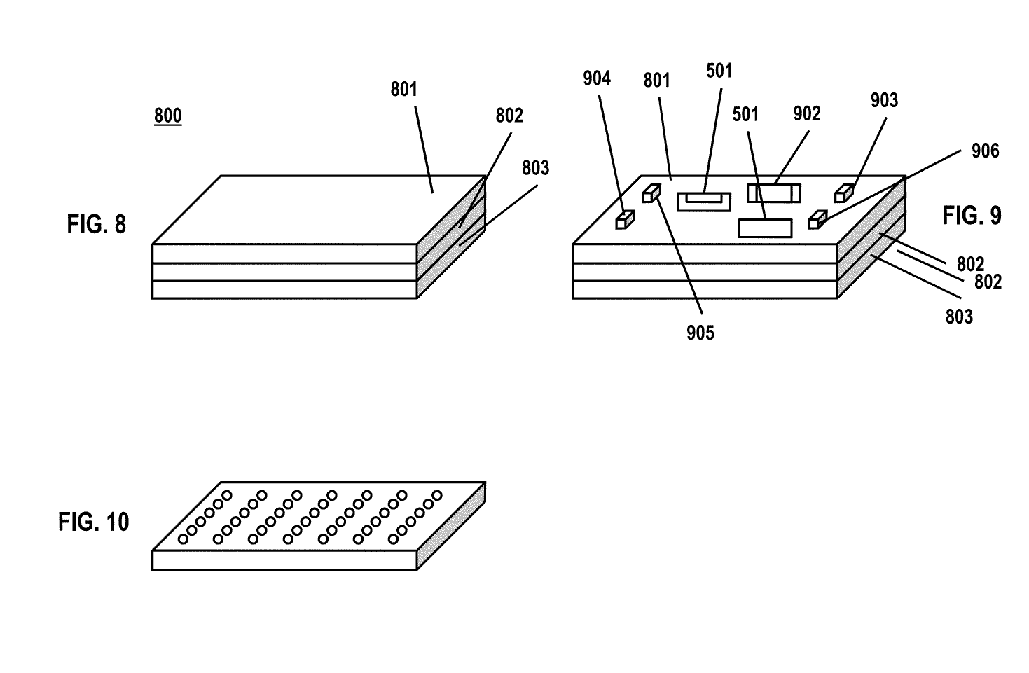

FIG. 8 is a perspective view of cooling off light board 800, which includes an isolation layer 801, an circuit layer 802, and aluminum heat sink layer 803. The cooling off light board may be a LED cooling off light board.

FIG. 9 is a view of the light board 800 with electronic components. The electronic components may include a power supply 501, at least one capacitor 902, at least one resistor 903, at least one integrated circuit 500, at least one transistor 905, at least one inductor 906, and at least one light emitting source 101. The light emitting source 101 may be a light emitting diode—LED. It is also contemplated that the cooling off layer 801 may be covered with thermally conducted epoxy 2301.

FIG. 10 is a perspective view of a cooling off board 800 with ventilation holes 102. It is contemplated that one or more boards may have one or more drilled holes in it, which may be of between 2 and 3 millimeters, or other sizes, to provide ventilation and heat management.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An adaptable light unit comprising:
a circuit plate including a plurality of layers, at least one of the layers is a heat dissipater;
a circuit controller,
a circuit, wherein the circuit includes a rectifier circuit, a light-emitting driver circuit, and a smoothing capacitor;
at least one light emitting source, wherein the light emitting source is caused to emit light by electricity that is transferred through the circuit controller;
a power fixture, wherein the power fixture is configurable to retrofit conventional light power fixtures.

2. An adaptable light unit of claim 1, wherein the adaptable light unit further comprises:
a securing fixture; and
a diffuser.

3. An adaptable light unit of claim 1, wherein the circuit plate is between 2 and 5 millimeters.

4. An adaptable light unit of claim 1, wherein the circuit plate includes a thermally conductive adhesive.

5. An adaptable light unit of claim 1, wherein the circuit includes an AC/DC converter.

6. An adaptable light unit of claim 1, wherein the light emitting source is blue, wherein the blue is not formed by any filter.

7. An adaptable light unit of claim 1, wherein the light-emitting driver circuit is LED light-emitting driver circuit.

8. An adaptable light unit of claim 1, wherein the circuit plate includes at least a plurality of capacitors and resistors.

9. An adaptable light unit of claim 15, wherein the switcher can be a set of voltage dependent capacitors.

10. An adaptable light unit of claim 15, wherein low OHM resistors are used in the switcher.

11. An adaptable light unit of claim 15, wherein the circuit controller reduces the heat of the light emitting unit.

12. An adaptable light unit of claim 1, wherein the circuit board includes AC input.

13. An adaptable light unit of claim 1, wherein the circuit plate includes a multiple current regulator.

14. An adaptable light emitting unit of claim 20, wherein the circuit controller includes a metal-oxide-semiconductor field-effect transistor.

15. A light panel system comprising:
an adaptable light emitting unit, wherein the adaptable light emitting unit is detachable from the light panel system frame;
a light panel system frame; wherein the frame includes a power track, fixtures, and electricity conductors; and
a hanger.

16. A system of claim 15, wherein the adaptable light emitting unit is attachable to the light panel system frame solely by a socket.

17. A system of claim 15, wherein the light panel system frame are capable of being connected concurrently to several adaptable light emitting units.

18. A system of claim 15, wherein the hanger has magnetic properties.

19. A system of claim 15, wherein the hanger is also an electricity conductor.

20. A system of claim 15, wherein the light panel system is formed by fixing several adaptable light emitting unit.
